(19) United States
(12) Patent Application Publication
(10) Pub. No.: US 2002/0168462 A1
(43) Pub. Date: Nov. 14, 2002

(54) Method of making an object of pet food

(76) Inventor: Corinne E. Jefferson, Santa Clarita, CA (US)

Correspondence Address: Gary Schnittgrund, Ph.D., LAW OFFICES OF GARY SCHNITTGRUND, 23030 Lyons Avenue, Suite 200, Santa Clarita, CA, 91321, US

(21) Appl. No.: 09/853,270

(22) Filed: May 9, 2001

(51) Int. Cl. A23K 1/00

(52) U.S. Cl. 426/623

(57) ABSTRACT

The invention relates to a method of producing self-supporting edible objects of bird or pet food.

Description of the related art including information disclosed under 37 CFR Secs. 1.97-1.99.

### BACKGROUND OF THE INVENTION

### Field of the Invention

This invention relates to a method of making an object of pet food for consumption by animals.

Birds, hamsters, cats, dogs and almost all domestic have become very popular pets leading to a need to reduce the amount of time spent feeding these pets and cleaning the domestic environment of the pets.

There is a need for edible objects made of pet food. Currently bird owners clean their bird's enclosure on a daily basis. The bird bowl that is used for feeding the bird a variety of foods to meet the dietary needs, is cleaned daily. The cleaning process is messy and time consuming. Soap, bleach and scrubbing are typical requirements to properly clean and disinfect the feeding bowls.

The instant invention is a method of making edible objects such as a bowl for feeding birds and other pets. The edible bowl is filled with the normal pet food according to its dietary needs. The pet eats its normal food and the pet then eats the bowl itself, which is comprised of ingredients that are chosen according to the needs of the particular pet being fed. The bowl is made of healthy foods, with no artificial preservatives added, that are hardened in baking thereby creating a hard and moderately abrasive material which helps to maintain the beak of birds and the teeth of other pets.

The edible object, such as a bowl, is stable during storage and yet it is completely edible and biodegradable. Because it is not reused, it does not need to be cleaned or disinfected, unlike a reusable conventional pet-feeding bowl. It can be disposed of or it can be crumbled up and fed to the pet at its next feeding cycle.

### SUMMARY OF THE INVENTION

The invention is a method of making a self-supporting object for feeding birds and other pets made from edible material, the object being of selected size and composition which depends on the particular needs of the birds or pets being fed.

### OBJECTS OF THE INVENTION

It is an object of the invention to produce a self-supporting edible object that is suitable for feeding birds.

It is an object of the invention to produce a self-supporting edible object that is suitable for feeding pets.

It is an object of the invention to produce a self-supporting bowl for feeding birds.

Other objects, advantages and novel features of the present invention will become apparent from the following detailed description of the invention when considered in conjunction with the accompanying drawing.

### BRIEF DESCRIPTION OF THE DRAWINGS

FIG. 1 is a schematic representation of the method of making objects of pet food.

### DETAILED DESCRIPTION OF THE PREFERRED EMBODIMENT

The objects, advantages and features of this invention will be more clearly perceived from the following detailed description when read in accordance with the accompanying figure in which:

The ingredients are characterized as dry or liquid ingredients. The dry ingredients are further divided into three groups: flour, seeds and other, and fruits or vegetables. The flour group includes: wheat flour, rye flour, brown rice flour, millet flour, and corn flour. The seeds and other group includes: flax seed, safflower seed, thistle seed, sun flower seed, alfalfa seeds, sesame seeds, millet seeds, canary seeds, finch seeds, large and small hooked bill seeds, salt, eggs shells, and grits. The fruits or vegetables group includes: dried fruit, dried vegetables, raisins, onion, garlic, eucalyptus leaves, fruit leaves, oats, rolled and popped corn.

The liquid ingredients are divided into three groups: broth, oil or other. The broth group includes: vegetable broth, chicken broth, meat broth, and fish broth. The oil group includes: flax seed oil, peanut butter. The other group includes: fruit juices [typically, apple, orange, or carrot juice], eggs, and water. The liquid may be added singly or in mixtures in order to achieve the desired flavor and consistency. The liquid is added as about 6 to 15% by weight.

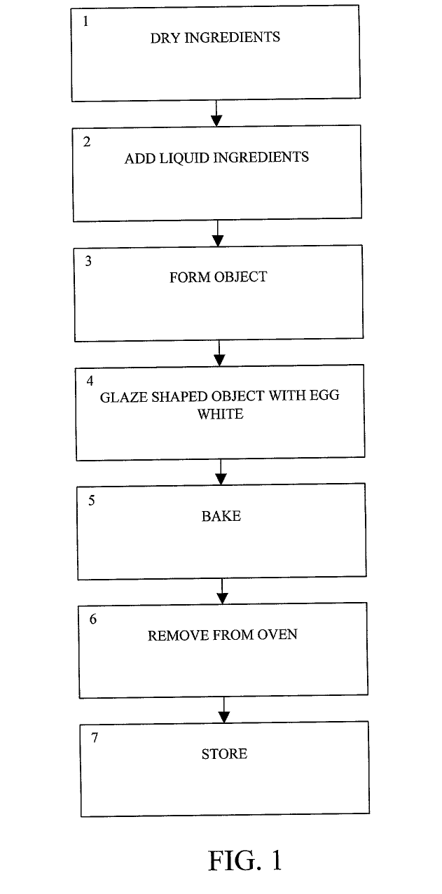

As depicted in the FIG. 1 schematic representation of steps, dry ingredients step 1 are selected depending upon the desired flavor of the object, the dietary needs of the bird or pet, and the physical size of the object to be produced. The selected ingredients are first mixed together dry in measured amounts.

A further advantage of adding eucalyptus leaves or garlic is that each acts as a natural pest control agent for the animal that consumes the edible object. In a preferred embodiment, garlic is added to an object that is made for dogs or cats as 1 clove of garlic to about ½ gallon of dry ingredients, while in a further preferred eucalyptus leaves are added to an object that is made for birds as about ¼ to ½ cup of eucalyptus leaves to 1 gallon of dry ingredients.

The liquid ingredients are added in step 2 and blended thoroughly with the dry ingredients by hand mixing, or mixing in a conventional food mixer or food blender. After mixing, the ingredients may be kneaded to eliminate stickiness and to final blend. Sufficient liquid ingredients are added to form a plastic material of adequate stiffness so that it may be readily formed into a shape without cracking, but of adequate strength so that it will retain the desired shape, such as a bowl.

The object is formed to its desired final shape step 3 by any conventional pastry process or combination of processes such as rolling the mixture, pressing, casting, and cutting.

The formed object from step 3 is coated with egg white wash in glazing step 4 to strengthen and to seal the object before baking step 5 so as to create a glaze on the object after it is baked. Egg white wash is made by mixing one egg white with one to two tablespoons of water. The glaze step 4 helps to bind the object together, making it stronger and less prone to damage during use, handling and storage, and giving the object a glossy finish that resists liquid penetration into the object.

It is desirable that the object remains hard when exposed to moist food, so as to not dissolve while holding the regular pet food and to maintain the objects hardness.

The object is then baked step 5 at approximately 250° to 300° F. for approximately 10 to 45 minutes until it is very hard, it is no longer losing weight by evaporation, and it has not burned. It is possible to prepare a suitable object by substituting other processes for conventional baking in an oven, such as microwave processing, infrared heating, dehydration, or freeze drying.

The object is cooled step 6 when it is removed from the oven before being stored step 7, preferably in an airtight container.

Because the object is stabilized and dried by the baking process, no artificial preservatives or chemicals are added to the object.

The following Examples illustrate a method of preparing an edible object of bird or pet food.

### Example A

A bowl for a canary having approximate dimensions of a 1/16 inch thick wall and is ¼ to ½ inch high with a diameter of 1 to ½ inches. The bowl is made of a composition having the following approximate proportions: 1 cup of brown rice flour, ½ cup of millet seed, 1 egg, ¼ cup of flax seed oil, ¼ cup eucalyptus leaves, ¼ cup of fruit juice, and ½ to 3 cups of vegetable broth added to achieve a consistency that is suitable to form the desired object. The bowl is baked approximately 15 to 30 minutes at 300° F.

### Example B

A bowl for a cockatoo or macaw having approximate dimensions of ¼ to ½ inch thick wall and 2 to 3 inches high with a diameter of about 3 to 4 inches. The bowl is made of a composition having the following approximate proportions: 1½ cups of millet flour, ¼ cup of eucalyptus leaves, 1 egg, ¼ cup of peanut butter, about 1 cup of vegetable broth added to achieve a consistency that is suitable to form the desired object. The bowl is baked approximately 30 to 45 minutes at 300° F.

### Example C

A bowl for a small dog or cat having approximate dimensions of ¼ to ½ inch thick wall and 3 to 6 inches in diameter. The bowl is made of a composition having the following approximate proportions: 2 cups wheat flour, ¼ cup alfalfa seed, ½ cup millet seed, 1 clove garlic, 1 onion, a pinch of salt, ¼ cup of flax seed oil and ¾ cup of meat broth. The bowl is baked approximately 30 to 45 minutes at approximately 300° F.

Obviously, many modifications and variations of the present invention are possible in light of the above teachings. It is therefore to be understood that, within the scope of the appended claims, the invention may be practiced other ways than as specifically described.

What is claimed is:

1. A method of making an edible object comprising:
selecting ingredients from the classes of dry ingredients and liquid ingredients where the dry ingredients are comprised of a flour group, seeds and other group, and fruits or vegetables group and the liquid ingredients are comprised of a broth group, oil group, and others group,
mixing dry ingredients together to form a homogeneous mixture,
adding a liquid ingredient to the dry ingredients,
mixing the liquid ingredient with the dry ingredients to form a homogeneous mixture,
forming an object to the desired final shape,
coating the object with an egg white wash,
baking the object,
removing the object from the oven.
cooling the object.

2. The method of claim 1 wherein:
the dry ingredients are comprised of at least one element from the group consisting of flour, up to three elements from the group consisting of seeds and other, and at least one element from the group consisting of fruits or vegetables.

3. The method of claim 2 wherein:
the liquid ingredients are comprised of at least one element from the group consisting of broth, at least one element from the group consisting of oil, and up to two elements from the group consisting of others.

4. The method of claim 1 wherein:
the liquid ingredients are comprised of at least one element from the group of peanut butter, fruit juice, vegetable broth, egg, and water,
the amount of liquid ingredients added to said dry ingredients is about 6 to 15% by weight of said dry ingredients.

5. The method of claim 1 wherein:
a pest control agent is added to the dry ingredients to provide a natural pest repellant to the edible object,
said pest control agent is added at less than one weight percent by weight of the dry ingredients.

6. The method of claim 1 wherein:
forming the object to the final shape is accomplished by rolling.

7. The method of claim 1 wherein:
said baking occurs at 250° to 300° F. for 20 to 45 minutes.

8. The method of claim 1 wherein:
the flour group consists of wheat flour, rye flour, brown rice flour, millet flour, and corn flour.

9. The method of claim 1 wherein:
the seeds and other group comprises flax seed, safflower seed, thistle seed, sun flower seed, alfalfa seeds, sesame seeds, millet seeds, canary seeds, finch seeds, large and small hooked bill seeds, salt, eggs shells, and grits.

10. The method of claim 1 wherein:
the fruits or vegetables group comprises dried fruit, dried vegetables, raisins, onion, garlic, eucalyptus leaves, fruit leaves, oats, rolled and popped corn.

11. The method of claim 1 wherein:
the broth group comprises vegetable broth, chicken broth, meat broth, and fish broth.

12. The method of claim 1 wherein:
the oil group comprises flax seed oil, peanut butter.

13. The method of claim 1 wherein:
the other liquid ingredient group comprises fruit juices, eggs, and water.

14. A method of making an edible bowl for birds comprising the steps:
selecting 1 egg,
measuring out 1 cup of brown rice flour,
measuring out ½ cup of millet seed,
measuring out ¼ cup of flax seed oil,
measuring out ¼ cup of fruit juice,
measuring out ½ to 3 cups of vegetable broth,
mixing the dry ingredients together to form a homogeneous mixture,
adding a liquid ingredient to the dry ingredients,
mixing the liquid ingredient with the dry ingredients to form a homogeneous mixture,
forming a bowl,
coating the object with an egg white wash,
baking the bowl for approximately 20 to 30 minutes at 300° F.,
removing the object from the oven.
cooling the object.

15. A method of making an edible bowl for dogs comprising the steps:
measuring out 2 cups of wheat flour,
measuring out ¼ cup of alfalfa seed,
measuring out ½ cup of millet seed,
selecting 1 clove of garlic,
selecting 1 onion,
measuring out a pinch of salt,
measuring out ¼ cup of flax seed oil,
measuring out ¾ cup of meat broth,
mixing the dry ingredients together to form a homogeneous mixture,
adding a liquid ingredient to the dry ingredients,
mixing the liquid ingredient with the dry ingredients to form a homogeneous mixture,
forming a bowl,
coating the bowl with an egg white wash,
baking the bowl approximately 30 to 45 minutes at 300° F.,
removing the bowl from the oven,
cooling the bowl.
